(19) United States
(12) Patent Application Publication
(10) Pub. No.: US 2007/0083422 A1
(43) Pub. Date: Apr. 12, 2007

(54) Method of testing an incentive compensation plan for fairness and equity

(76) Inventor: John Keon, Stamford, CT (US)

Correspondence Address: COOPER & DUNHAM, LLP, 1185 AVENUE OF THE AMERICAS, NEW YORK, NY, 10036, US

(21) Appl. No.: 11/520,986

(22) Filed: Sep. 14, 2006

Related U.S. Application Data
(60) Provisional application No. 60/717,441, filed on Sep. 14, 2005.

(51) Int. Cl. G06F 11/34

(52) U.S. Cl. 705/11

(57) ABSTRACT

A method of testing an incentive compensation (“IC”) plan tests whether the plan computes incentive compensation to various participants in a fair manner, considering the differences in various characteristics that impact success in their job responsibilities, independently of their performance, such as, for a sales force as one example, characteristics of product class trends, territory size, market share, and market conditions. The fairness test may also test for stability and attainment tests. If the testing reveals unfairness, the plan may be redefined to reduce the unfairness.

### CROSS-REFERENCE TO RELATED APPLICATION

This application claims priority on provisional application U.S. Ser. No. 60/717,441, filed Sep. 14, 2005, which is incorporated by reference herein.

### BACKGROUND OF THE INVENTION

The present invention relates to a method for testing an Incentive Compensation (“IC”) plan to determine whether it meets fair and equitable criteria.

Companies use IC plans typically to provide compensation in the form of performance bonuses to pay for varying levels of job performance toward a goal, as an incentive to make the employees work harder towards achieving the goal. An IC plan can be created for persons with different job responsibilities or can be created for each group of employees who share similar job responsibilities. For example, the sales persons of a company-those responsible for getting sales-are usually participants in an IC plan.

Examples of IC plans are described in U.S. Pat. Nos. 6,055,511 and 6,636,852, incorporated by reference herein.

The '511 patent simply calculates incentive compensation for each participant based on apportionment from a pool, the pool being a certain amount of income over expenses.

The pool is then apportioned among participants based on per capita, or dependent on base salary or length of service.

The '852 patent bases incentive compensation on sales quotas, but does not appear to specify how the quotas are determined, and whether this quota system results in unfairness.

Typical IC plans are deficient in that they do not provide for any (or if they do, insufficient) consideration for equity and fairness factors in defining the incentive compensation. To the extent that any evaluation of fairness of incentive compensation determination has been done, it has been based on unreliable and inconsistent subjective judgments, and based on anecdotal stories of participants who subjectively believed that they were being treated fairly or unfairly. There does not appear to be any systematic or reliable way to objectively, and in a statistically reliable and mathematically repeatable way, evaluate whether an IC plan determines compensation based on a participant's performance and effort, controlled for environmental or market characteristics or conditions outside the control of the participant.

### SUMMARY OF THE INVENTION

The present invention provides a method for testing an IC plan for participants such as employees and sales personnel, to ensure that the incentive compensation determined under the IC plan is “fair and equitable” to those participants in the IC plan. This testing, sometimes called herein “Equity and Fairness testing,” at its most basic level is testing to determine whether each participant of the IC plan has an equal opportunity to earn as much bonus incentive-compensation as every other member in the IC plan given their current job grade, performance and effort.

The testing of Equity and Fairness of an IC plan includes any test which examines the IC plan and all its participants, to determine if all participants have an equal opportunity at earning the same level of incentive-compensation bonus for their performances and efforts. The tests are conducted to see if the:
1) Performance Measures are defined such that one group, or individual, has an unjust advantage over other groups or individuals who are participating in the IC plan.
2) Setting of Goals that provide one group or individual an unjust advantage over other groups of individuals who are participating in the IC plan.
3) Setting of Payout amounts for performance, or achievement of goals in such a manner that it favors one group, or individual, over other groups or individuals.
4) Structuring the IC plan, through a combination of the above features, so as to favor one group or individual over other groups or individuals.

Tests of Equity and Fairness can be conducted at different levels of rigor. At the less rigorous level, a Test of Equity and Fairness can be the application of an If-then Rule to test fairness. For example a simple IF-then Statement test which examines Performance Measures may be:

If Sales volumes and trends are very different across the individual areas of responsibility for the different IC plan participants and Either Performance Measure involves measures of sales volume, Or Goals are set which don't explicitly take into account these differences in sales volume and trends, Then the IC plan fails on an Equity and Fairness Test.

More rigorous Equity and Fairness Tests can be conducted which involve the statistical analysis of the degree of bias that is obtained for different performers utilizing projected performance results.

By testing IC plans according to the invention, and by making any appropriate adjustments to the performance measures or goals as needed to achieve fairness and equity, the invention also provides an IC plan which provides incentive compensation for participants using criteria wherein each participant has an equal opportunity to earn as much incentive compensation as every other participant given their current job grade, based on their performance and effort.

The invention provides a method for evaluating the fairness of an incentive compensation (“IC”) plan to determine the fairness or equity of the IC plan's treatment of IC plan participants whose performances are being evaluated and whose incentive compensation is being determined based on the IC plan, comprising determining whether there are any characteristics that cause at least one performance metric being evaluated by the IC plan to be biased so that the inventive compensation determined under the IC plan favors at least one participant over another participant.

The invention provides a method for evaluating the fairness of an incentive compensation (“IC”) plan, said method comprising the steps of:
(a) identifying at least one performance metric that is used to evaluate the performance of participants of the IC plan;
(b) identifying the mathematical formulation being used to translate different values of the performance metric into incentive compensation to the IC plan participants;
(c) identifying existing characteristics of the areas where performance is being evaluated that might impact the performance metric being used by the IC plan;
(d) determining whether the existing characteristics are correlated with, or statistically related to, performance metric values of IC plan participants; and
(e) evaluating whether the findings from step (d) constitute an unfair advantage for any participant of the IC plan.

The invention provides a method for evaluating the fairness of an incentive compensation (“IC”) plan, comprising systematically evaluating the performance or projected performances of the IC participants to determine if the mathematical dispersion of incentive compensation determined under the IC plan indicates that the IC plan has a methodology of evaluating their incentive compensation that is unfair, or contains biases in favoring at least one participant over another participant.

### BRIEF DESCRIPTION OF THE DRAWING

FIG. 1 shows the results of a Stability Test of Equity for an IC plan; and

FIG. 2 shows a Ranking of Attainments for an Ideal Quota or Goal.

### DETAILED DESCRIPTION OF A Preferred EMBODIMENT

An example of a testing technique will be described with reference to participants who are employed in a sales force of a business entity. However, the invention is not limited to such an application.

The invention provides a method for evaluating the fairness of an incentive compensation (“IC”) plan to determine the fairness or equity of the IC plan's treatment of IC plan participants whose performances are being evaluated and whose incentive compensation is being determined based on the IC plan, comprising determining whether there are any characteristics that cause at least one performance metric being evaluated by the IC plan to be biased so that the inventive compensation determined under the IC plan favors at least one participant over another participant.

The invention provides a method for evaluating the fairness of an incentive compensation (“IC”) plan, said method comprising the steps of:
(a) identifying at least one performance metric that is used to evaluate the performance of participants of the IC plan;
(b) identifying the mathematical formulation being used to translate different values of the performance metric into incentive compensation to the IC plan participants;
(c) identifying existing characteristics of the areas where performance is being evaluated that might impact the performance metric being used by the IC plan;
(d) determining whether the existing characteristics are correlated with, or statistically related to, performance metric values of IC plan participants; and
(e) evaluating whether the findings from step (d) constitute an unfair advantage for any participant of the IC plan.

The step (d) may include the step of determining if the existing characteristics are correlated with or statistically related to the performance metric values of IC plan participants' actual performances, or projected or forecasted performances.

The step (e) may include the step of quantitatively evaluating the degree of unfair advantage to provide a quantitative rating of unfairness of the IC plan.

The participants may be selected from the group consisting of individuals, groups of individuals working together, sales territories, accounts, teams of individuals, machines, and group of entities.

The characteristic may be at least one of product class trend, territory size, market share, and market conditions.

The method may further include the step of redefining the mathematical formulation to decrease the unfair advantage.

The invention provides a method for evaluating the fairness of an incentive compensation (“IC”) plan, comprising systematically evaluating the performance or projected performances of the IC participants to determine if the mathematical dispersion of incentive compensation determined under the IC plan indicates that the IC plan has a methodology of evaluating their incentive compensation that is unfair, or contains biases in favoring at least one participant over another participant.

The method as set forth immediately above may include the step of quantitatively determining the level of unfairness or bias.

The method may further include the step of reformulating the IC plan to decrease the level of unfairness or bias.

As used herein, the term “characteristics” means attributes or characteristics which effect the performance of an IC plan participant independently of, or not directly correlated with, the effort expended by an IC plan participant. Such examples of characteristics include market conditions and market characteristics.

As used herein, the term “incentive compensation” includes any form of monetary or non-monetary payment, compensation or benefits including, without limitation, cash, stock, stock options, compensation or comp time, vacation time, or bonus.

As used herein, the term “area” includes geographical territory, geographical region, product line, product category, duties assigned, account type of customer, or groups of customers.

As used herein, the term “participant” includes an individual, or a group or team of individuals working together in an area (as defined herein), or on an account, or any teams of individuals, machines, or group of entities being evaluated and compared on their performance.

As used herein, the term “fair” with reference to IC plan compensation, means a determination of compensation for a participant based on a participant's effort, controlling for and taking into account market and environmental conditions and characteristics or other factors outside the control of the participant.

As used herein, the term “unfair” with reference to IC plan compensation, means a determination of compensation for a participant not based solely on a participant's effort, without control or taking into account market and environmental conditions and characteristics or other factors outside the control of the participant.

An IC plan should ideally have Equity and Fairness testing to ensure that each participant of the IC plan has an equal opportunity to earn as much compensation as every other member in the IC plan given their current job grade.

The present invention provides a method of testing an IC plan which passes at least one, and most preferably all, of four sets of tests that examine different characteristics of the IC plan for Equity and Fairness. Each of these tests deal with:
Performance Measures
Setting Goals
Setting Payouts
Structuring the IC plan

The differences between these four sets of tests are that they examine different elements of an IC plan that can cause it to be unfair to the participants. These four sets of tests are:
Fairness Tests of Equity—Are all participants treated equally, or are there innate characteristics that exist in the duties to be performed that put certain participants, because of the area and/or duties that they are assigned that put certain participants at an advantage or disadvantage to other participants? The Fairness Tests examines all the innate characteristics for fairness.
Stability Test of Equity—Is the IC plan structured so that the same participants succeed year after year while others fail? Or alternatively does the IC plan cause the winners of last year to be the losers this year? Is there a built-in bias to the IC plan that ensures either of these stability symptoms occur? This test looks at this inequity.
Attainment Test of Equity—If goals are set equitably, and participants in the IC plan have equal capabilities and expend the same effort, then they should all achieve similar levels of success. The distribution of the levels of success tells us a lot about the equity of the goal setting method. This test examines whether the goals are set equitably.
Bias Test of Equity—This test examines how the IC plan is structured and tests if a pattern exists among some feature that would suggest that the IC plan is biased.

In describing these Tests of Equity it is important to understand how these tests identify conditions that undermine the integrity of the IC plan that calls for participants to be compensated on his or her performance, and not on the basis of prejudicial judgments or pre-existing conditions.

Fairness Tests

The Equity test of Fairness evaluates an IC plan as to whether it has characteristics that bias the results so one group of participants is favored over another. To show how this is accomplished consider an Incentive Compensation plan that is designed for a Sales Force. The IC plan is going to pay on the sales performance of each Sales Person. One can test for Fairness for the following factors or criteria:
a) Sales Trend of the Product Class (our companies products plus competitive products)
b) Territory Size
c) Market Share of our Product in the Product Class
d) Market Conditions that influence sales for each territory

The purpose of each test is to see if the condition is affecting the IC plan's Performance Measures such that one group of territories has a prejudicial advantage over the other territories.

Let us look at each of these Fairness Tests in turn for a fictitious Vascular Product called “Proderil”.

Product Class Trend Fairness Test

Different parts of the country have different Product Class Trends. These differences can be caused by demographic shifts, weather conditions that favor the increased adoption of a Product Class, and sometimes just speed of adoption for a new kind of product because of life style or other differences across the country. Depending on the Product Class, the geographical differences in trend can undermine the fairness of an IC plan. To understand how, let us consider the common case of one territory with a Product Class trend moving upward (“Trend up territory”) (as would be the case caused by a demographic movement of people into a territory) versus a territory with a negative Product Class trend, i.e. a Product Class trend moving downward (“Trend Down territory”). Assume that each territory has the same amount of Proderil Sales Volume this period and that each territory grows its market share from 50% to 55%. The two territories, from a Fairness stand point, should be evaluated relatively the same in performance. Let us see how they compare:

| | Total Mkt | | % |
|---|---|---|---|
| | Sales Last Qtr | Total Mkt Current Qtr | Change |
| Trend Up territory | 1000 | 1200 | 20% |
| Trend Down territory | 1000 | 800 | −20% |

Now both territories grew their Proderil Market Share from 50% to 55%:

| | Proderil Sales | Proderil Sales | Sales |
|---|---|---|---|
| | (50% Mkt Shr) | (55% Mkt Shr) | % Change |
| Trend Up territory | 500 | 660 (55% of 1200) | 32% |
| Trend Down territory | 500 | 440 (55% of 800) | −12% |

From the above chart, one can see that the territory with an upward Product Trend increased in Sales Volume much more than the territory with a downward Product Trend. While both territories grew Proderil Share, just because of the demographic differences that consumers were moving into one territory and leaving another, one territory is enjoying a 660 versus a 440 Sales volume advantage. That could be characterized as Unfair if compensation under the IC plan is based solely on % change in sales, without considering the baseline sales trend which exists without regard to market share.

Product Class Trend Fairness Test can be conducted in a less rigorous IF-Then statement that the tester can apply to the situation. In this example the statement would read as follows:

```
If ...
    Product Class Trends are different across territories, and
Either...
    Performance involves measures of sales volume
Or ...
    Go als are set which don't explicitly take into account Product Class
    Trends
Then ...
    The IC plan will fail the Product Class Trend Fairness Test.
```

At the more rigorous end of testing for Fairness, this test would be accomplished by statistically projecting the Product Class Trend at either Territory or District level and seeing if wide variations in Trends across the country would have a high impact on the IC plan performances across the country if all other factors were held constant. This test is done by 1) Creating Product Trend forecasts at the territory or district level and then 2) providing simulated performances for every territory while holding all else constant, and 3) returning a statistical level of Fairness given the results.

The statistical test is a test of Analysis of Variance, or more precisely a One-Way Analysis of Variance (“ANOVA”) that tests the performances of the sales persons generated under the simulations. One can test the hypothesis that the sales persons in a given region did not perform statistically different that the sales persons in any other region. That is, one can test the null hypothesis that there is “no difference” in the population performances between the different regions. One can test the null hypothesis that the mean performances of each region are identical. The degree to which the null hypothesis holds, that all regions are identical, is the degree to which the IC plan is fair concerning the element being tested, which in this case is the Product Class Trend.

Let us now look at each of the other Fairness Tests

Territory Size Fairness Test

The basic inequity of an IC plan that fails the Territory Size Fairness Test is easier to discern. The concept behind the test to is determine whether territories with a large sales size have an advantage (or disadvantage) over territories with small sales size.

To illustrate this problem, consider the case of one territory with a Product Class Market size that is large, and one with a small Product Class Market size. (We will assume that the Product Class trend is flat in both cases).

| | Total Mkt Sales 1^{st} QTR |
|---|---|
| Large territory | 1000 |
| Small territory | 500 |

Now let both territories have the same market share of 50%

| | Proderil Sales (50% Mkt Sh.) 1^{st} QTR |
|---|---|
| Large territory | 500 |
| Small territory | 250 |

One can see that the territory with the larger size has a huge advantage over the smaller territory regarding any performance measure that would include volume—such as a commission based plan. Similarly, many Goal setting methods which might allocate Goal based on existing sales and not Potential (what is commonly referred to as Allocating Goal by Contribution) have a high risk of failing our Market Volume Fairness Test. In terms of our IF-THEN test for this condition:

```
If ...
      Product Class Market sizes are very different across territories, and
    Either...
      Performance involves measures of sales volume
    Or ...
      Goals are set which don't explicitly take into account Market Sizes
    Then ...
      The IC plan could fail the Territory Size Fairness Test.
```

Mathematically testing for Fairness on Size is a bit more difficult than for Product Class Trend. Every Company has territories that differ in Market Size. The question is one of degree. At what point does the difference in Market sizes across the territories impact on the fairness of an IC plan? Statistically one can still test the same null hypothesis, except this time one is not looking at differences between regions, but rather whether the degree to which the performance of a sales person is correlated with the size of the territory. The degree to which Market Share size, and simulated projected sales person performances are correlated indicates the degree to which the IC plan is unfair, or the degree to which the IC plan fails the Territory Size Fairness Test.

Market Share Fairness Test

The Market Share Fairness Test has at its basis the assumption that two territories with different market share, if they increase their sales proportionately then:
a) Both territories should be considered equivalent in performance; or
b) The higher market share territory should be considered to have a slightly better performance than the lower market share territory. The reasoning is that the lower market share should have an easier time increasing its sales by say 10%, than would the larger market share territory.

This test, in light of these assumptions, examines the IC plan to determine if differences in Market Share cause one territory to have an undo advantage over another.

This test is a bit harder to evaluate than the Trend Test or the Size Test because some Companies actually want to bias the results in favor of those territories which started the planning period with larger Market Shares. One should adjust this test for those companies. Let us now examine attributes of this condition.

Consider the case of one territory with a Market Share size that is high, and one with a low Market Share Size.

| | Total Mkt Sales | Proderil Sales | Proderil Share |
|---|---|---|---|
| High Market Share | 1000 | 600 | 60% |
| Low Market Share | 1000 | 300 | 30% |

Because of the differences in share, Performance Measures that consider % change of either market share or volume might be at risk of penalizing the larger market share. This would be because the territories which start with a smaller share could gain a larger % change very quickly because their starting base is so small. On the other hand, performance measures that consider volume might be at risk of penalizing the smaller market share territories. For example, with territories of relatively equal size, a performance measure like commission on volume would favor the higher market share territories.

```
If ...
      Market Shares are very different across territories, and
    Either...
      Performance involves measures of sales volume
    Or...
      Performance involves measures of % change
    Or...
      Goals do not consider potential but only contribution
    Then ...
      The IC plan could fail the Market Share Fairness Test.
```

Again, this If statement provides a less rigorous test for evaluating an IC plan on Market Share Fairness Test.

The statistical and more rigorous test does the following:
1) Examines the spread of Market Shares across the country.
2) Applies a simulated sales projection down to a territory.
3) Determines if the IC plan contains a Market Share bias when performances are examined. This is done by measuring the degree of correlation between the market share sizes and the sales persons' performances.
   Market Conditions Fairness Test

To test an IC plan on Market Conditions influence, one should first differentiate between the territories with constrictive Marketing Conditions versus all others. For simplicity we will talk about Market Condition Challenged Territories (MCC territories) versus other territories that are not MCC. This test examines the Impact of Market Conditions by examining whether past performances of the MCC territories are statistically different than those of the other territories when the IC plan Performance Measures are used.

The IF-THEN statement for Market Condition Fairness Test is harder to interpret. It is:

```
If ...
    All else being equal, MCC territories perform significantly different
    from other territories
Then ...
The IC plan fails the Managed Care Fairness Test.
```

Statistically, how this Fairness test is conducted, is that one identifies the MCC territories and tests whether, as a group, it has expected performance (via a simulation) that is significantly better or worse than the other territories when taken as a group. That is a simple hypothesis test: “are the average performances of the MCC territories the same as the average performances of all other territories?” The degree to which this hypothesis is held not to be true is the degree to which the IC plan fails the Market Conditions Fairness Test.

Stability Test of Equity

How often has an IC plan been adopted that year after year has the same people at the top? Or alternatively one sees the Top Performers one year becoming the Bottom Performers the next year? This never-changing ranking of performances and flip-flopping in performance are two symptoms of what is caused by a malady of the IC plan that either penalizes or rewards past performance. To understand the Inequity of an IC plan that fails the Stability Test, let's examine both of these two conditions.

Any IC plan should have a certain amount of “Stability”. That is, a company's best Sales Reps should tend to finish near the top. However, some IC plans are not equitable, and they basically ensure that those people who finished well last year will finish well again this year.

Here is an actual example of a simple IC plan that failed the Inertia Test of Equity. It was an IC plan that was used on a Sales Force that had very unequal market sizes. The Performance measure used was “absolute volume change as measured in Total Prescriptions versus last year's total Prescriptions. This Sales Force had one territory that was three times larger than the next largest territory. The problem, of course, was that the smallest territories would need to double their volume just to equal what this largest territory could achieve with just a 5% increase. Not surprisingly, the same territories tended to finish on top, while the same territories finished near the bottom year after year—it was totally correlated with the size of the territory's market.

The alternative side of this same problem is when an IC plan punishes the best performers of the prior year causing Sales Reps' rankings to flip-flop from year to year. Let's look at a company which has an IC plan with flip-flopped performance rankings from one year to the next. The reason was because of the Goal setting method it uses. This company took the trend of each territory and then added an additional % increase to each territory to arrive at the Goal. To understand how this worked consider two Territories A and B. Territory A's trend indicated a 20% increase and Territory B indicated a 5% increase. Goal was set to be the territory's trend plus 10%.

| | Last | This | | | |
|---|---|---|---|---|---|
| | Year's | Year's | | | |
| | Sales | Sales | Change | Required | New |
| | increase | increase | in Sales | additional | Goal |
| Territory A | 1000 | 1200 | 20% | 10% | 20% + 10% = |
| | | | | | 30% |
| Territory B | 1000 | 1100 | 5% | 10% | 5% + 10% = |
| | | | | | 15% |

While the Goal setting sounds equitable—it isn't. The Territory that worked hard last year and increased sales by 20%, now has to work that much harder this year to make Goal. (In my example above, Territory A's new Goal is an increase of 30% while Territory B's is an increase of only 15%). With this IC plan the best improving territories of last year are penalized while last year's poorly improving territories get a break. Such an IC plan ensures a flip-flopping of performance from year to year.

It may not be easy to discern whether or not an IC plan will pass the Stability Test of Equity before the actual test is conducted. The actual test however, is very helpful in making sure that an IC plan will be equitable in its treatment of past performances.

The Stability Test of Equity may be conducted by ranking the performances of every Sales Rep using the rules of the IC plan being tested. The IC plan is applied to the last two years for which the company employing the Sales Rep has data to get a Sales Rep's ranking in performance for both years. One can then compare how each Sales Rep ranked both years. To do this statistically, one can create a statistic which is the absolute shift in rankings that occurred for each Sales Rep. (A Sales Rep that finished 23^{rd} last year and 14^{th} this year would have shifted 9 places). One can add up the total amount of absolute shifting that occurred for the Sales Force between the two years. One can then compare this total amount of shifting observed, with the amount of shifting that would occur if Rankings were random.

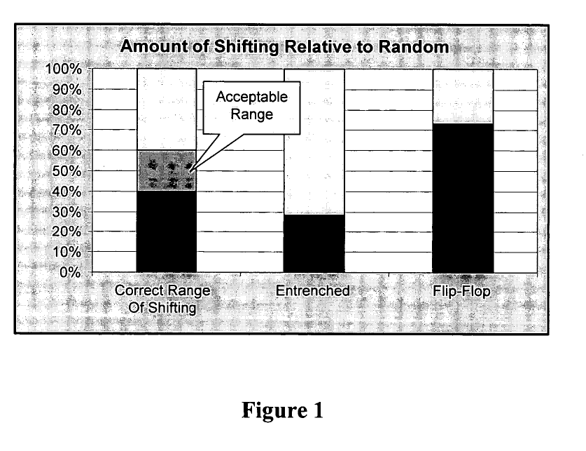

The Stability Test of Equity compares the amount of shifting that occurs for an IC plan relative to Complete Random Shifting (which is calculated mathematically). FIG. 1 shows the output from our Stability Test of Equity. The first bar shows the range for IC plans that are acceptable on our Stability Test of Equity (ranging from 40% to 60% of Random shifting).

The second bar in FIG. 1 shows the performance of an Entrenched IC plan that had tremendous inertia in it. This plan was extremely biased and ensured that the same Reps did well year after year. Such IC plan will have less than 40% of the shifting that would occur with a random shifting. (Realize we use the Random level to provide a reference with which to compare all IC plans.). This IC plan was very biased with a shifting of less than 30% which is highly unusual.

The third bar in FIG. 1 is for an IC plan that was biased against the top performers of the prior year. This IC plan saw the top performers of the prior year become the low performers of the present year and vice versa for the low performers of the prior year. These Flip-Flop IC plans will have test results that run higher than 70% of random. They can, in fact, have shifting that even surpasses the randomness level.

How do we correct for such results? The problems that cause failure on the Stability Test of Equity may be hard to detect. The factors that can cause failure depend on an IC plan that uses past behavior in establishing future expectations—but this is true for most IC plans. One can correct this problem by creating slightly different IC plans, and test the altered IC plan to see if one obtains improvement in the Stability Test results or not. This may be an arduous process, unless the element that is causing the failure becomes readily apparent after studying the IC plan. Simulation models in the Pharma IC planner™ System developed by The Marketing Advantage can be used to project results to conduct the Stability Test.

Attainment Test of Equity

The Attainment Test of Equity is a powerful test that was developed to evaluate the Equity of the Goal, or sometimes the Quota, setting method. Is the Goal setting method used in the IC plan equitable?

The question is “How does one know if the Goals are being set correctly?” The Attainment Test of Equity was designed to test this. The underlying assumption of the test is that if Goals are set perfectly, then most of a company's participants should have an attainment around 100%. There should be some who exceed the 100% attainment, and some portion who should fall short of their 100% attainment. But for the most part, the participants should all come in around 100%.

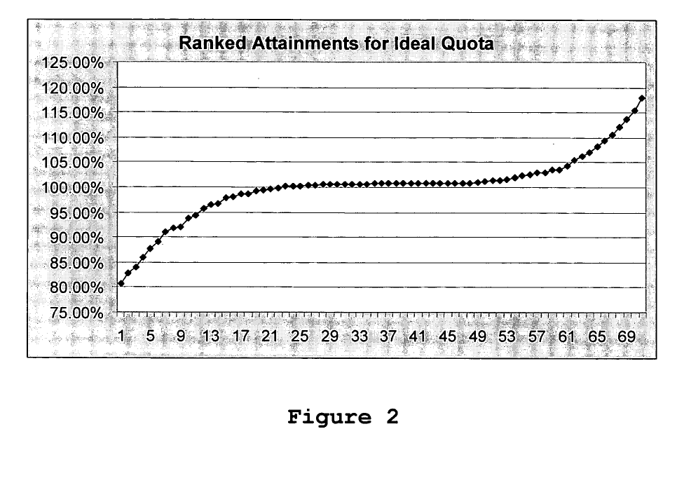

FIG. 2 shows the distribution of attainment that one would get with an ideal Goal setting method. This figure shows the Participants attainment ranked from lowest attainment (80.6%) to the highest attainment level (118%). Note that 80% of the participants' attainments fall within a few points of 100% attainment. Now as is sometimes the case when setting Goals, the National Sales Target might first be set and then that total Goal is allocated out to the Territories. Sometimes the National Sales Target is more a wish then an accurate number. In those cases the Goal attainments will fall short of the 100%. However, the shape of the attainment curve should still be what is seen in FIG. 2, only that instead of being centered around 100%, the curve is centered around some lower attainment level.

The actual Attainment test examines this curve using last year's data and the Goal setting method as it would have been applied a year earlier to calculate the Goals. One then examines the attainment curve that is obtained using the estimated Goal and last year's sales data. The test examines the attainment level of the middle 66% and how far these attainments deviate from the average Goal attainment level. The absolute variation of this middle 66% from the mean attainment is an indicator of just how good is the Goal setting method. The smaller the change between the extreme ends of this middle 66% indicates how well the IC plan performs on the Attainment Test of Equity. The larger the difference in the attainments of the persons at either end of the middle 66% ranking, the less equitable is the IC plan on Attainment Test of Equity.

Bias Test of Equity

The Bias Test of equity is a statistical test that holds the various attributes of an IC plan constant and tests a single attribute. The participants' performances are simulated and the performances are compared relative to the value of the single attribute being tested. If the performances and the single attribute are correlated, then the attribute causes an inequity in the IC plan.

Using the criteria and tests set forth above, one is able to test an existing or proposed IC plan to determine whether it meets one or more of the tests of equity and fairness.

While a method of testing an IC plan has been described, the present invention is not limited to the method described, and the scope of the invention is defined by the appended claims.

What is claimed is:

1. A method for evaluating the fairness of an incentive compensation (“IC”) plan to determine the fairness or equity of the IC plan's treatment of IC plan participants whose performances are being evaluated and whose incentive compensation is being determined based on the IC plan, comprising:
determining whether there are any characteristics that cause at least one performance metric being evaluated by the IC plan to be biased so that the inventive compensation determined under the IC plan favors at least one participant over another participant.

2. A method for evaluating the fairness of an incentive compensation (“IC”) plan, said method comprising the steps of:
(a) identifying at least one performance metric that is used to evaluate the performance of participants of the IC plan;
(b) identifying the mathematical formulation being used to translate different values of the performance metric into incentive compensation to the IC plan participants;
(c) identifying existing characteristics of the areas where performance is being evaluated that might impact the performance metric being used by the IC plan;
(d) determining whether the existing characteristics are correlated with, or statistically related to, performance metric values of IC plan participants; and
(e) evaluating whether the findings from step (d) constitute an unfair advantage for any participant of the IC plan.

3. The method as set forth in claim 2, wherein step (d) includes the step of determining if the existing characteristics are correlated with or statistically related to the performance metric values of IC plan participants' actual performances, or projected or forecasted performances.

4. The method as set forth in the claim 2, wherein step (e) includes the step of quantitatively evaluating the degree of unfair advantage to provide a quantitative rating of unfairness of the IC plan.

5. The method as set forth in claim 2, wherein the participants are selected from the group consisting of individuals, groups of individuals working together, sales territories, accounts, teams of individuals, machines, and group of entities.

6. The method as set forth in claim 2, wherein the characteristic is at least one of product class trend, territory size, market share, and market conditions.

7. The method as set forth in claim 2, further including the step of redefining the mathematical formulation to decrease the unfair advantage.

8. A method for evaluating the fairness of an incentive compensation (“IC”) plan, comprising systematically evaluating the performance or projected performances of the IC participants to determine if the mathematical dispersion of incentive compensation determined under the IC plan indicates that the IC plan has a methodology of evaluating their incentive compensation that is unfair, or contains biases in favoring at least one participant over another participant.

8. The method as set forth in claim 7, including the step of quantitatively determining the level of unfairness or bias.

10. The method as set forth in claim 7, further including the step of reformulating the IC plan to decrease the level of unfairness or bias.
